(19) United States
(12) Patent Application Publication
(10) Pub. No.: US 2014/0044909 A1
(43) Pub. Date: Feb. 13, 2014

(54) PROTECTOR FOR PROTECTING AND ATTACHING AN EXTERNAL OBJECT TO A CLOTH

(71) Applicant: Hao Shi, Redondo Beach, CA (US)

(72) Inventor: Hao Shi, Redondo Beach, CA (US)

(21) Appl. No.: 13/571,764

(22) Filed: Aug. 10, 2012

(51) Int. Cl. B32B 33/00; B32B 37/00

(52) U.S. Cl. 428/41.7; 156/60

(57) ABSTRACT

One example embodiment includes a system for attaching an external object to a cloth. The system includes a first layer and a second layer, where at least a portion of the second layer is attached to the first layer. The system also includes an attachment, where the attachment is configured to attach the first layer to a cloth.

### CROSS-REFERENCE TO RELATED APPLICATIONS

This application is related to co-pending U.S. application Ser. No. ______/______,______, filed on ______, 2012, and entitled, “SYSTEM FOR ATTACHING AN EXTERNAL OBJECT TO A CLOTH” (Attorney Docket No. 10371.5), which application is incorporated herein by reference in its entirety.

This application is related to co-pending U.S. application Ser. No. ______/______,______, filed on ______, 2012, and entitled, “BADGE FOR ATTACHING AN EXTERNAL OBJECT TO A CLOTH” (Attorney Docket No. 10371.7), which application is incorporated herein by reference in its entirety.

### BACKGROUND OF THE INVENTION

Many people use clothing to send a message about themselves. I.e., their selection of clothing is often a reflection of the wearer or of a statement that the wearer intends to make. For example, clothing can include a political or cultural statement. Clothing can reflect a wearer's values or include brand names that the wearer either likes or supports.

However, clothing tends to often be mass produced with the result that many people own the same article. Because of this the wearer may wish to personalize his/her clothing. I.e., the wearer may wish to add certain decorations to his/her clothing. The decorations can include any 3D or 2D object which is added to the clothing. For example, the decorations the wearer desires to add can include a picture or other print.

However, customizing clothing can be an expensive and time consuming process. In particular, printing or adding designs to clothing can require expensive machinery. Often, the cost of such customization requires scale in order to become cost efficient. Therefore, some services which can customize clothing require minimum orders. I.e., an order must include a minimum number of clothing pieces to be customized or the order will be refused.

In addition, the more customization to be done, the more expensive the process. That is, a small amount of text or design costs less than a larger amount of text or design. Therefore, the customization may be limited to a small amount of design. I.e., the cost limitation to a high degree of customization may be difficult to overcome, especially for an individual or small order.

Further, this customization is permanent. I.e., the customization is printed directly onto the clothing and is difficult to remove without damaging the clothing. This means that once the decision has been made to add a certain customization, the decision may be permanent with respect to a particular garment.

Accordingly, there is a need in the art for a system which can allow a user to easily customize clothing. In addition, there is a need in the art for the system to be changeable. Further, there is a need in the art for the customization to allow the addition of larger designs.

### BRIEF SUMMARY OF SOME EXAMPLE EMBODIMENTS

This Summary is provided to introduce a selection of concepts in a simplified form that are further described below in the Detailed Description. This Summary is not intended to identify key features or essential characteristics of the claimed subject matter, nor is it intended to be used as an aid in determining the scope of the claimed subject matter.

One example embodiment includes a system for attaching an external object to a cloth. The system includes a first layer and a second layer, where at least a portion of the second layer is attached to the first layer. The system also includes an attachment, where the attachment is configured to attach the first layer to a cloth.

Another example embodiment includes a system for attaching an external object to a cloth. The system includes a first layer and a second layer, where at least a portion of the second layer is attached to the first layer. The system also includes an attachment, where the attachment is configured to attach the first layer to a cloth. The system further includes a closure, where the closure is configured to releasably attach a portion of the first layer to the second layer. The system additionally includes an edging, where the edging is attached to the second layer opposite the first layer.

Another example embodiment includes a method for manufacturing a system for attaching an external object to a cloth. The method includes providing a first layer. The method also includes attaching at least a portion of the second layer to the first layer. The method further includes connecting an attachment to the first layer. The attachment is connected to the first layer opposite the second layer and is configured to attach the first layer to a cloth.

These and other objects and features of the present invention will become more fully apparent from the following description and appended claims, or may be learned by the practice of the invention as set forth hereinafter.

### BRIEF DESCRIPTION OF THE DRAWINGS

To further clarify various aspects of some example embodiments of the present invention, a more particular description of the invention will be rendered by reference to specific embodiments thereof which are illustrated in the appended drawings. It is appreciated that these drawings depict only illustrated embodiments of the invention and are therefore not to be considered limiting of its scope. The invention will be described and explained with additional specificity and detail through the use of the accompanying drawings in which:

FIG. 1 illustrates an example of a system for customizing a cloth;

FIG. 2 illustrates an example of the system attaching a decoration to a cloth;

FIG. 3 illustrates an example of an alternative system attaching a decoration to a cloth;

FIG. 4 illustrates an example of an alternative system for customizing a cloth;

FIG. 5 illustrates an example of an edging;

FIG. 6 illustrates an example of a 3D attachment; and

FIG. 7 is a flow chart illustrating a method of manufacturing a system for customizing a cloth.

### DETAILED DESCRIPTION OF SOME EXAMPLE EMBODIMENTS

Reference will now be made to the figures wherein like structures will be provided with like reference designations. It is understood that the figures are diagrammatic and schematic representations of some embodiments of the invention, and are not limiting of the present invention, nor are they necessarily drawn to scale.

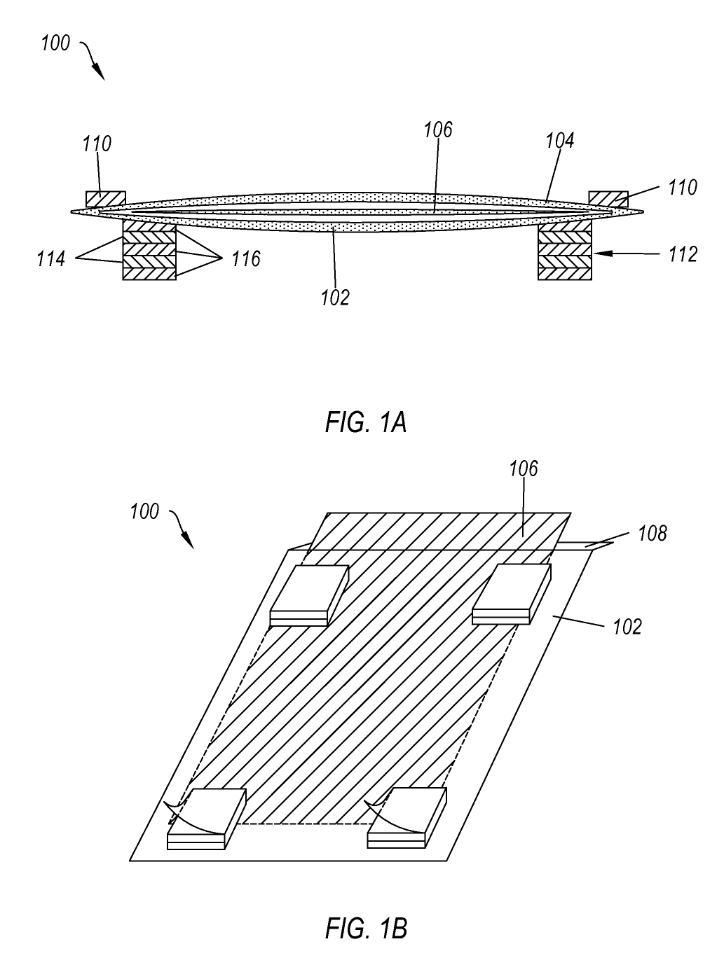

FIG. 1 illustrates an example of a system 100 for customizing a cloth. In at least one implementation, the cloth can include clothing, other cloth and cloth-like materials. I.e., the system 100 can allow a user to customize the look of his/her clothing. Additionally or alternatively, the system 100 can allow the user to customize upholstery or other furniture coverings. One of skill in the art will appreciate that any cloth can be customized and that clothing and cloth and examples and not limiting herein unless otherwise specified in the claims.

FIG. 1 shows that the system 100 includes a first layer 102. In at least one implementation, the first layer 102 can include any desired material. For example, the first layer 102 can include paper, plastic film, cloth, metal foil or any other desired material. The first layer 102 can be any desired size and shape. For example, the user may be able to cut or otherwise reshape the first layer 102. The first layer 102 can be include coloring or decorations or can be transparent or semi-transparent.

FIG. 1 also shows that the system 100 can include a second layer 104. In at least one implementation, the second layer 104 is at least partially attached to the first layer 102. For example, the first layer 102 and the second layer 104 can form a “pouch” or other shape that is able to receive an external object. One of skill in the art will further appreciate that the first layer 102 and the second layer 104 can be either permanently attached or releasably attached, as described below. One of skill in the art will further appreciate that leaving a portion of the first layer 102 and the second layer 104 unattached can allow a user to insert or remove an external object, as described below. The second layer 104 can include a transparent or semi-transparent material. For example, the second layer 104 can include plastic, cloth, paper or any other desired material.

FIG. 1 further shows that the system 100 can include a decoration 106. In at least one implementation, the decoration 106 can be placed between the first layer 102 and the second layer 104 with the decoration 106 at least partially visible through the second layer 104. I.e., the first layer 102 and the second layer 104 hold the decoration 106 and allow for attachment to a cloth, allowing a user to display the decoration 106 on the cloth.

FIG. 1 additionally shows that the system 100 can include a closure 108. In at least one implementation, the closure 108 can be configured to releasably attach any portion of the edge of the first layer 102 and the second layer 104. I.e., the closure 108 can “close” any unattached edges of the first layer 108 and the second layer 104. For example, the closure 108 can include a flap, seal connection or any other mechanism for releasably attaching the opening between the first layer 102 and the second layer 104.

FIG. 1 also shows that the system 100 can include an edging 110. In at least one implementation, the edging 110 can allow a user to customize the edges of the second layer 104. I.e., the edging 110 can releasably attach to the second layer 104, allowing the user to create an effect or frame to complement the decoration 106. One of skill in the art will appreciate that the edging 110 can be substantially flat or can have depth, as desired by the user. One of skill in the art will further appreciate that the edging can be customized by the user. For example, the edging can be painted or decorated by the user or the user can apply patterns, such as tapes or other adhesives.

FIG. 1 further shows that the system 100 can include an attachment 112. In at least one implementation, the attachment 112 can allow a user to attach the system 100 to an external device. In particular, the attachment 112 can create a releasable attachment, allowing the system 100 to be attached and detached as desired. For example, the attachment 112 can be used to attach the system 100 to a cloth, as described below.

FIG. 1 shows that the attachment 112 can include a base layer 114. In at least one implementation, the base layer 114 can include any desired material. For example, the base layer 114 can include paper, plastic film, cloth, metal foil or any other desired material. The base layer 114 can be any desired size and shape in order to secure the system 100. For example, the user may be able to cut or otherwise reshape the base layer 114. The base layer 114 can be include coloring or decorations or can be transparent or semi-transparent.

FIG. 1 also shows that the attachment 112 can include an adhesive layer 116. In at least one implementation, the adhesive layer 116 is configured to attach the system 100 to a cloth. I.e., the adhesive layer 116 can attach the base layer 114, structures attached thereto, to the cloth. The adhesive layer 116 can include a pressure sensitive adhesive. Pressure sensitive adhesive (PSA, self-adhesive, self-stick adhesive) is adhesive which forms a bond when pressure is applied to marry the adhesive with the adherend. I.e., no solvent, water, or heat is needed to activate the adhesive

FIG. 1 also shows that the attachment 112 can include multiple sections of base layer 114 and adhesive layer 116. I.e., the first base layer 114 can serve as a backing for an adhesive layer 116. Additionally or alternatively, the multiple sections of base layer 114 and adhesive layer 116 can include a backing to protect the adhesive layer 116. The backing layer can attach the multiple sections to one another can protect the adhesive layer 116 until desired use. This can allow the system 100 to be attached to the cloth multiple times. I.e., the user can remove the system 100 as desired and reattach using a new base layer 114 and adhesive layer 116.

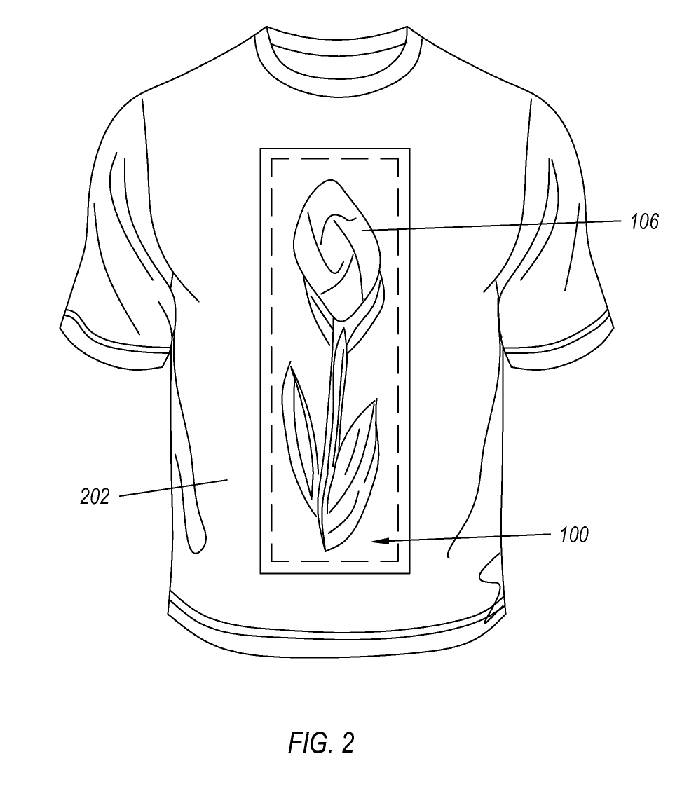

FIG. 2 illustrates an example of the system 100 attaching a decoration 106 to a cloth. In at least one implementation, the system 100 can be releasably attached or the decoration 106 can be removed from the system 100 as desired. I.e., the decoration 106 can be attached/inserted and removed/replaced as desired by the wearer. Additionally or alternatively, different decorations 106 can be attached to the cloth, as desired.

FIG. 2 shows that the first adhesive layer can attach to a cloth 202. In at least one implementation, the cloth 202 can include any desired material. For example, the cloth 202 can include leather, artificial leather, suede, vinyl, a fabric or any other desired material. The cloth 202 can be used for any desired purpose. For example, the cloth 202 can include clothing, bedding, upholstery covers or any other desired covering or material.

Leather is a durable and flexible material created via the tanning of putrescible animal rawhide and skin, primarily cattlehide. Artificial leather includes any fabric or finish intended to substitute for leather where a leather-like finish is desired but the actual material is cost-prohibitive or unsuitable. Suede includes kid or other leather finished with a soft, napped surface, on the flesh side or on the outer side after removal of a thin outer layer. Vinyl includes any resin formed by polymerization of vinyl compounds or plastics made from such resins. A vinyl compound is any organic compound that contains a vinyl group (Preferred IUPAC name ethenyl). Vinyl groups (formula —CH═CH2) are derivatives of ethene, CH2═CH2, with one hydrogen atom replaced with some other group.

Fabrics include any network of natural or artificial fibers including textiles. In at least one implementation, the fibers can include thread or yarn. For example, yarn can be produced by spinning raw wool fibers, linen, cotton, or other material on a spinning wheel to produce long strands. Fabrics can be formed by weaving, knitting, crocheting, knotting, or pressing fibers together, such as in felt. One of skill in the art will appreciate that a fabric can include a single fiber or more than one fiber.

In at least one implementation, fibers, also spelled fibres, is a class of materials that are continuous filaments or are in discrete elongated pieces. In particular, fibers can be spun into filaments, string or rope, used as a component of composite materials, or matted into sheets to make products such as paper or felt. Additionally or alternatively, fibers can include yarn, thread, string, filaments, twine, cord, or any other material that can be used to form a fabric or cloth. In particular, yarn is a long continuous length of interlocked fibers, suitable for use in the production of textiles, sewing, crocheting, knitting, weaving, embroidery and rope making. Additionally or alternatively, thread is a type of yarn intended for sewing by hand or machine. Yarn and/or thread may be finished with wax or other lubricants to withstand the stresses involved in sewing or otherwise manufacturing the fabric.

Natural fibers can include animal fibers such as alpaca, angora, bison down, camel hair, cashmere, catgut, chiengora, guanaco, llama, mohair, pashmina, qiviut, rabbit, silk, sinew, spider silk, wool, vicuna, and yak; vegetable fibers such as aback bamboo, coir, cotton, flax, hemp, jute, kapok, kenaf, pina, raffia palm, ramie, sisal, and wood; mineral fibers such as asbestos, basalt, mineral wool, and glass wool; and cellulose fibers such as acetate, art silk, bamboo, lyocell (tencel), modal, and rayon; or any other natural fiber. Synthetic fibers can include acrylic, aramid (twaron, kevlar, technora, and nomex), carbon (tenax), derclon, microfiber, modacrylic, nylon, olefin, polyester, polyethylene (dyneema, spectra), spandex, vinalon, zylon, or any other synthetic fiber. One of skill in the art will appreciate that fibers can include any natural or synthetic fibers, or any combination thereof, without restriction and without limitation unless otherwise indicated in the claims.

In at least one implementation, the fibers can be used to form a grid. In particular, the first set of fibers can be oriented in a “horizontal” direction; that is, the first set of fibers can be oriented parallel to one another. One of skill in the art will appreciate that horizontal orientation refers to an arbitrary orientation and is not used to limit or restrict the scope of the claims unless otherwise indicated in the claims. Further, the first set of fibers can be spaced equidistant from one another or in a repeating pattern. For example, a first fiber in the first set of fibers might be relatively close to a second fiber in the first set of fibers, which is, in turn, relatively farther from a third fiber in the first set of fibers, with the pattern repeating throughout the fabric. One of skill in the art will appreciate that the spacing of the first set of fibers can be any distance from one another without restriction and without limitation unless otherwise indicated in the claims.

The second set of fibers can be oriented in a “vertical” direction; that is, the second set of fibers can be oriented parallel to one another. One of skill in the art will appreciate that vertical orientation refers to an arbitrary orientation perpendicular to the first set of fibers and is not used to limit or restrict the scope of the claims unless otherwise indicated in the claims. Further, the second set of fibers can be spaced equidistant from one another or in a repeating pattern. For example, a first fiber in the second set of fibers might be relatively close to a second fiber in the second set of fibers, which is, in turn, relatively farther from a third fiber in the second set of fibers, with the pattern repeating throughout the fabric. One of skill in the art will appreciate that the spacing of the second set of fibers can be any distance from one another without restriction and without limitation unless otherwise indicated in the claims.

In at least one implementation, the fibers can be woven together. In particular, weaving is the textile art in which a first set of fibers and a second set of fibers, called the warp and the filling or weft (older woof), respectively, are interlaced with each other to form a fabric or cloth. In particular, the first set of fibers can be held in place while the second set of fibers is woven through them or vice versa. The manner in which the first set of fibers and the second set of fibers interlace with each other is known as the weave. In particular, the weave can include plain weave, satin weave, and twill or any other type of weave.

In at least one implementation, plain weave can include the first set of fibers and second set of fibers aligned so they form a simple criss-cross pattern. Each fiber in the second set of fibers crosses the first set of fibers by going over one, then under the next, and so on. The next fiber in the second set of fibers goes under the first set of fibers that its neighbor went over, and vice versa. The satin weave is characterized by four or more fibers in the second set of fibers floating over a fiber in the first set of fibers or vice versa, four or more fiber in the first set of fibers floating over a single fiber in the second set of fibers. Twill is a type of fabric woven with a pattern of diagonal parallel ribs. It is made by passing the second set of fibers over one or more first set of fibers and then under two or more first set of fibers and so on, with a “step” or offset between rows to create the characteristic diagonal pattern.

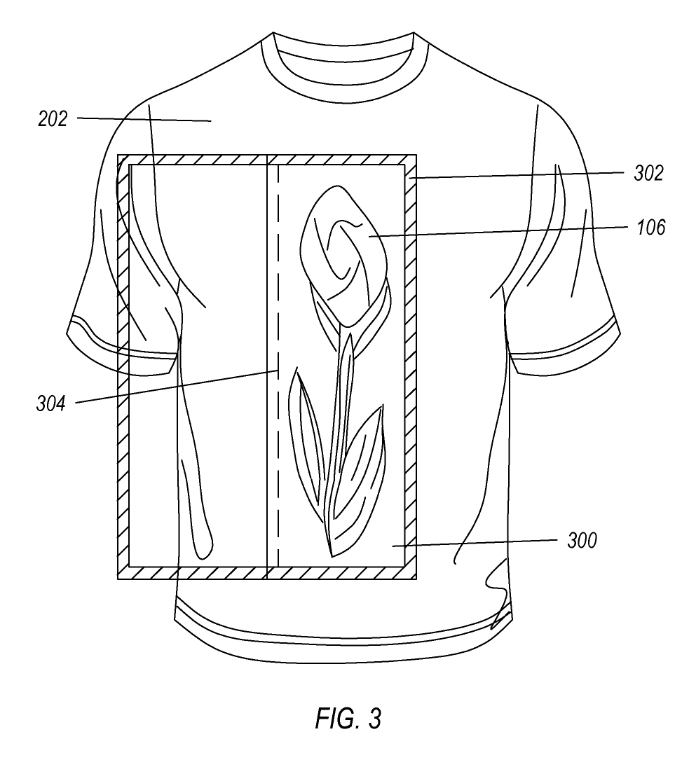

FIG. 3 illustrates an example of an alternative system 300 attaching a decoration 106 to a cloth. In at least one implementation, the decoration 106 can be releasably attached. I.e., the decoration 106 can be attached and removed as desired by the wearer. Additionally or alternatively, different decorations 106 can be attached to the cloth, as desired.

FIG. 3 shows that the system 300 can include a releasable seal 302. In at least one implementation, the releasable seal 302 can allow the first layer 102 and the second layer 104 to releasably attach to one another. In particular, the releasable seal 302 can attach the first layer 102 to the second layer 104 in a manner that the user can separate the first layer 102 and the second layer 104 as desired.

FIG. 3 also shows that the system 300 can include a permanently attached edge 304. In at least one implementation, the permanently attached edge 304 can ensure the proper orientation of the first layer 102 and the second layer 104. I.e., it can allow the first layer 102 and the second layer 104 to be substantially separated while retaining the correct alignment.

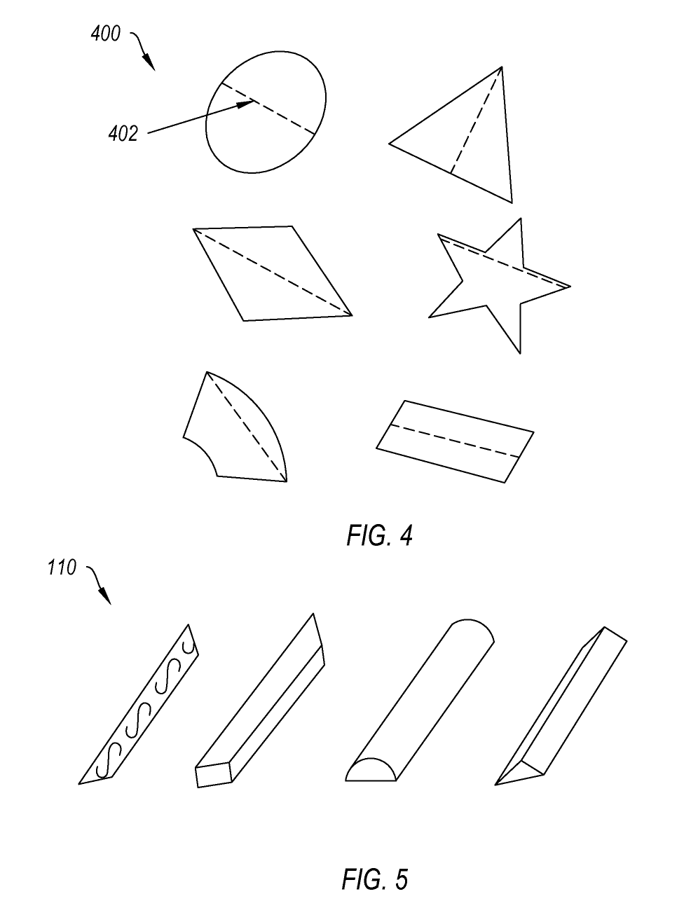

FIG. 4 illustrates an example of an alternative system 400 for customizing a cloth. In at least one implementation, the alternative system 400 can allow for alternative methods of placing the decoration 106 within the system 400. I.e., the alternative system 400 can better secure the decoration 106 for long term use.

FIG. 4 shows that the system 400 can include an opening 402 in the first layer 102. In at least one implementation, the opening 402 can be separated to allow a decoration 106 to be inserted. I.e., the opening 402 is closed or substantially closed without the application of force. However, a moderate amount of force will be sufficient to separate the flaps and allow access to the interior of the system 400.

FIG. 4 also shows that the system 400 can include multiple shapes. One of skill in the art will appreciate that any desired shape is contemplated herein. I.e., the first layer 102 and the second layer 104 can be formed into any desired shape and the examples of FIG. 4 are not limiting unless otherwise specified in the claims.

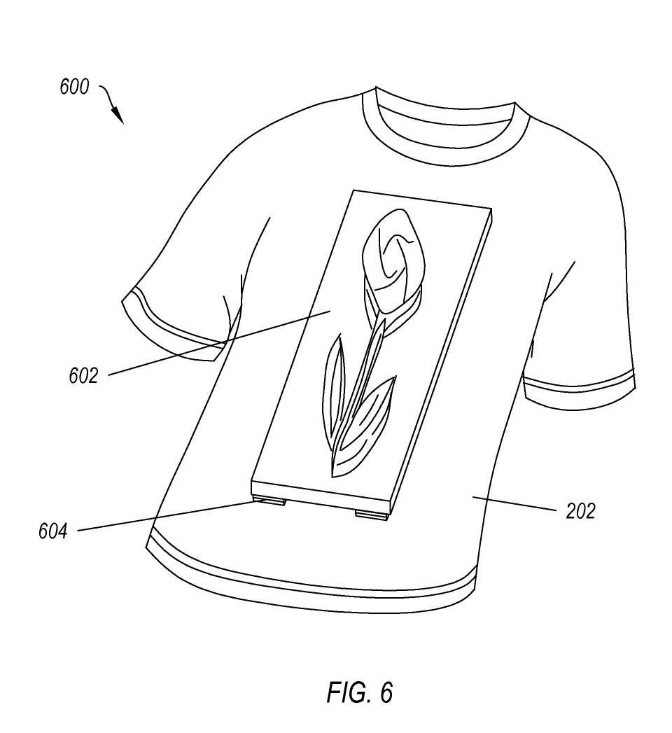

FIG. 5 illustrates an example of an edging 110. In at least one implementation, the edging 110 can allow a user to customize the edges of the second layer. I.e., the edging 110 can releasably attach to the second layer, allowing the user to create an effect or frame to complement the decoration. One of skill in the art will appreciate that the edging 110 can be substantially flat or can have depth, as desired by the user. One of skill in the art will further appreciate that the edging can be customized by the user. For example, the edging can be painted or decorated by the user or the user can apply patterns, such as tapes or other adhesives.

FIG. 5 shows that the edging 110 can include any desired shape. For example, the edging can be flat, rounded, triangular, rectangular, square or any other desired shape. One of skill in the art will appreciate that any desired shape is contemplated herein. I.e., the edging can be formed into any desired shape and the examples of FIG. 5 are not limiting unless otherwise specified in the claims.

FIG. 6 illustrates an example of a 3D attachment 600. In at least one implementation, the 3D attachment 600 can allow a user to further customize a cloth 202. For example, the 3D attachment 600 can allow a user to attach an object with depth and shape to the cloth 202. In particular, the 3D attachment can be any desired shape or size, as desired by the user.

FIG. 6 shows that the 3D attachment 600 can include a body 602. In at least one implementation, the body 602 can include a design to be attached to the cloth 202. In particular, the body 602 can include a 3D shape or object to be attached to the cloth 202. The body 602 can be made of any desired material. For example, the body 602 can be made of polyurethane or any other material. Additionally or alternatively, the body 602 can serve as a base for attachment of artwork. In particular, a picture or other desired design can be attached to the body 602 using adhesive or another attachment.

FIG. 6 also shows that the 3D attachment 600 can include an attachment 604. In at least one implementation, the attachment 604 can allow a user to attach the 3D attachment 600 to an external device. In particular, the attachment 604 can create a releasable attachment, allowing the 3D attachment 600 to be attached and detached as desired. For example, the attachment 604 can include an adhesive attachment as described above. Additionally or alternatively the attachment 604 can include a hook and loop fastener, a magnetic attachment or any other desired attachment.

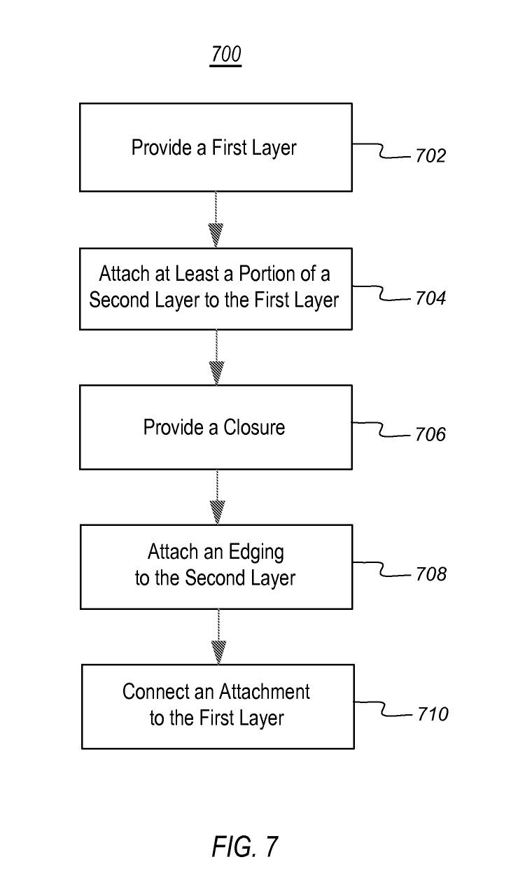

FIG. 7 is a flow chart illustrating a method 700 of manufacturing a system for customizing a cloth. In at least one implementation, the system can include the system 100 of FIGS. 1-3. Therefore, the method 700 will be described, exemplarily, with reference to the system 100 of FIGS. 1-3. Nevertheless, one of skill in the art can appreciate that the method 700 can be used to produce a system other than the system 100 of FIGS. 1-3.

FIG. 7 shows that the method 700 can include providing 702 a first layer. In at least one implementation, the first layer can include any desired material. For example, the first layer can include paper, plastic film, cloth, metal foil or any other desired material. The first layer can be any desired size and shape. For example, the user may be able to cut or otherwise reshape the first layer. The first layer can be include coloring or decorations or can be transparent or semi-transparent.

FIG. 7 also shows that the method 700 can include attaching 704 at least a portion of a second layer to the first layer. In at least one implementation, the second layer is at least partially attached to the first layer. For example, the first layer and the second layer can form a “pouch” or other shape that is able to receive an external object. One of skill in the art will further appreciate that the first layer and the second layer can be either permanently attached or releasably attached, as described below. One of skill in the art will further appreciate that leaving a portion of the first layer and the second layer unattached can allow a user to insert or remove an external object, as described below. The second layer can include a transparent or semi-transparent material. For example, the second layer can include plastic, cloth, paper or any other desired material.

FIG. 7 further shows that the method 700 can include providing 706 a closure. In at least one implementation, the closure can be configured to releasably attach any portion of the edge of the first layer and the second layer. I.e., the closure can “close” any unattached edges of the first layer and the second layer. For example, the closure can include a flap, seal connection or any other mechanism for releasably attaching the opening between the first layer and the second layer.

FIG. 7 additionally shows that the method 700 can include attaching 708 an edging to the second layer. In at least one implementation, the edging can allow a user to customize the edges of the second layer. I.e., the edging can releasably attach to the second layer, allowing the user to create an effect or frame to complement the decoration. One of skill in the art will appreciate that the edging can be substantially flat or can have depth, as desired by the user.

FIG. 7 also shows that the method 700 can include connecting 710 an attachment to the first layer. In at least one implementation, the attachment can allow a user to attach the system to an external device. In particular, the attachment can create a releasable attachment, allowing the system to be attached and detached as desired.

One skilled in the art will appreciate that, for this and other processes and methods disclosed herein, the functions performed in the processes and methods may be implemented in differing order. Furthermore, the outlined steps and operations are only provided as examples, and some of the steps and operations may be optional, combined into fewer steps and operations, or expanded into additional steps and operations without detracting from the essence of the disclosed embodiments.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A system for attaching an external object to a cloth, the system comprising:
a first layer;
a second layer, wherein at least a portion of the second layer is attached to the first layer; and
an attachment, wherein the attachment is configured to attach the first layer to a cloth.

2. The system of claim 1, wherein the attachment includes:
an adhesive layer, wherein the adhesive layer:
is applied to the first layer opposite the second layer; and
is configured to releasably attach the first layer to the cloth.

3. The system of claim 2 further comprising a backing, wherein the backing is configured to protect the adhesive layer.

4. The system of claim 2 further comprising:
a base layer, attached to the adhesive layer; and
a second adhesive layer, wherein the second adhesive layer:
is applied to the base layer opposite the adhesive layer; and
is configured to releasably attach the base layer to the cloth.

5. The system of claim 2 further comprising a cloth attached to the first adhesive layer.

6. The system of claim 5, wherein the cloth includes an article of clothing.

7. The system of claim 6, wherein the cloth includes a fabric.

8. The system of claim 2, wherein the first adhesive layer includes a pressure sensitive adhesive.

9. The system of claim 1 further comprising a decoration between the first layer and the second layer.

10. The system of claim 9, wherein the decoration includes a picture.

11. A system for attaching an external object to a cloth, the system comprising:
a first layer;
a second layer, wherein at least a portion of the second layer is attached to the first layer;
an attachment, wherein the attachment is configured to attach the first layer to a cloth;
a closure, wherein the closure is configured to releasably attach a portion of the first layer to the second layer; and
an edging, wherein the edging is attached to the second layer opposite the first layer.

12. The system of claim 11, wherein the second layer is transparent.

13. The system of claim 11, wherein the second layer includes plastic.

14. The system of claim 11, wherein the closure includes a flap, wherein the flap is configured to fold over an unattached edge of the first layer and the second layer.

15. The system of claim 11, wherein the first layer includes plastic.

16. A method for manufacturing a system for attaching an external object to a cloth, the method comprising:
providing a first layer;
attaching at least a portion of the second layer to the first layer; and
connecting an attachment to the first layer, wherein the attachment:
is connected to the first layer opposite the second layer; and
is configured to attach the first layer to a cloth.

17. The method of claim 16 further comprising:
providing a closure, wherein the closure is configured to releasably attach a portion of the first layer to the second layer.

18. The method of claim 16 further comprising:
providing an edging, wherein the edging is attached to the second layer opposite the first layer.

19. The method of claim 16 further comprising a releasable seal, wherein the releasable seal releasably attaches the first layer to the second layer.

20. A system for customizing a cloth, the system comprising:
a body, wherein the body includes a 3D attachment configured to be attached to a cloth;
an attachment, wherein the attachment is configured to attach the body to the cloth.
